(19) United States
(12) Patent Application Publication
(10) Pub. No.: US 2005/0283771 A1
(43) Pub. Date: Dec. 22, 2005

(54) System and method for decreasing the memory footprint of applications with automatic memory management systems

(75) Inventor: Gabor Paller, Budapest (HU)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/874,140

(22) Filed: Jun. 22, 2004

(51) Int. Cl. G06F 9/45

(52) U.S. Cl. 717/151; 717/148; 717/118

(57) ABSTRACT

The techniques described ease the work of garbage collectors by reducing the garbage produced. These embodiments combine the data-flow analysis of native compilers with an extension of the Java Virtual Machine (JVM). A special bytecode is inserted into the original bytecode to explicitly free unused objects. As a result, the garbage collector does not see the object that was explicitly reclaimed and the object doesn't reserve memory after it is not used anymore. The memory footprint of the JVM decreases and the responsiveness is better because the garbage collector has less work and, thus, it interrupts the application more rarely and for less time.

### BACKGROUND OF THE INVENTION

1 . Field of the Invention

The present invention relates generally to memory management of computer applications. More particularly, the present invention relates to a system and method for decreasing the memory footprint of applications that uses an automation memory management.

2 . Description of the Related Art

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Java is a simple, object-oriented, distributed, interpreted, robust, secure, architecture-neutral, portable, multithreaded, dynamic, buzzword-compliant, general-purpose programming language developed by Sun Microsystems in the 1990's. Java is similar to C++ without operator overloading (though it does have method overloading), without multiple inheritance, and extensive automatic coercions. It has automatic memory management which is called garbage collection.

Java programs can run stand-alone on small computers. The interpreter and class support take about 40 kilobytes; adding the standard libraries and thread support (essentially a self-contained microkernel) adds an additional 175 Kb. Java extends C++'s object-oriented facilities with those of Objective C for dynamic method resolution. Java has an extensive library of routines for TCP/IP protocols like HTTP and FTP. Java applications can access objects across the Internet via URLs as easily as on the local file system.

The Java compiler and linker both enforce strong type checking-procedures must be explicitly typed. Java supports the creation of virus-free, tamper-free systems with authentication based on public-key encryption. The Java compiler generates an architecture-neutral object file executable on any processor supporting the Java run-time system. The object code consists of bytecode instructions designed to be both easy to interpret on any machine and easily translated into native machine code.

Java's garbage-collected heap is the main attraction of the Java system because it eliminates or at least decreases the possibility of a common programming error, the memory leak. Unfortunately, the garbage-collected heap needs necessarily more memory than normal memory management. This is due to the fact that there is time between the generation of the garbage object (the time when an object is not referenced anymore therefore its space can be freed) and the time when the garbage collector thread finds enough spare time in the system and can reclaim the garbage object's space for new allocations. Java programs, therefore, occupy more memory than conventional programs. This memory requirement is a significant barrier to Java's adoption in the mobile terminal world. Java object libraries are such that certain common operations (like string manipulations) generate large amount of garbage objects. Decreasing Java's memory footprint can bring big benefits.

Prior attempts to solve the memory requirements of Java have been made. For example, Java runtimes have included more and more efficient garbage collectors generational garbage collectors being state of the art. (See, http://java.sun.com/docs/hotspot/gc1.4.2/faq.html) Native Java compilers have used data-flow analysis to find out which objects can be allocated on the stack instead of the garbage-collected heap. (See Choi, Gupta, Serrano, Sreedhar and Midkiff (IBM T.J Watson Research Center): Escape analysis for Java. OOPSLA99, Denver, 1999.) Another attempted solution requires the programmer to mark what objects can be allocated on what heap section. (See JSR-1, Real-time specification for Java, http://www.icp.org/en/isr/detail?id=1) The Microsoft .NET framework uses a similar garbage collection system as Java. Other programming languages use bytecode and garbage collection, including—for example—C#, Lisp, Objective-C, PHP, Perl, Python, Smalltalk, VBA, Visual Basic and VBScript.

Thus, there is a need to ease the work of the garbage collector by significantly reducing the garbage produced, thereby allowing programs to run faster and need less memory. Further, there is a need to decrease memory footprint to facilitate adoption in the mobile terminal world. Even further, there is a need for a system and method for decreasing the memory footprint of applications.

### SUMMARY OF THE INVENTION

In general, exemplary embodiments described herein ease the work of garbage collectors by reducing the garbage produced. These embodiments combine the data-flow analysis of the Java bytecode with an extension of the Java Virtual Machine (JVM). Information is added to the Java bytecode that explicitly describes which object can be freed at certain location of the program. For example a special bytecode can be inserted into the original bytecode to explicitly free unused objects. As a result, the garbage collector does not see the object that was explicitly reclaimed and the object doesn't reserve memory after it is not used anymore. The memory footprint of the JVM decreases and the responsiveness is better because the garbage collector has less work and, thus, it interrupts the application more rarely and for less time.

One exemplary embodiment relates to a method of decreasing memory footprints produced in an object-oriented programming environment. This method includes analyzing compiled code to identify objects to be reclaimed and modifying the compiled code to include instruction to reclaim objects found from said analysis.

Another exemplary embodiment relates to a system for decreasing memory footprints in an object-oriented programming environment. The system includes a pre-processor configured to find no escape points in object-oriented code and insert an unused object flag into the code to free unused objects in the object oriented code, a virtual machine that executes the object-oriented code, and a garbage collector that frees objects in a garbage collection heap containing used objects from executed object-oriented code. The code having the unused object flag does not go into the garbage collection heap and does not have to be freed by the garbage collector.

Another exemplary embodiment relates to a device that has object-oriented programming code executed thereon. The device includes a memory configured to contain object-oriented code, a processor that performs a data flow analysis on the object-oriented code to determine objects that can be reclaimed, wherein the processor inserts special instructions in objects that can be reclaimed, and a garbage collection heap configured to store unneeded objects until said unneeded objects can be freed. The garbage collection heap is a space in the memory and the garbage collection heap does not contain objects determined in data flow analysis.

Another exemplary embodiment relates to a computer program product that reduces memory needed to execute object-oriented code. The computer program product includes computer code to insert a special bytecode into an original bytecode to identify objects to be reclaimed, wherein identified objects are no longer in use and computer code to reclaim the identified objects such that the identified objects do not reserve memory after not being used anymore.

Yet another exemplary embodiment relates to a module that decreases memory requirements for object-oriented code. The module includes a memory structure and a pre-processor. The memory structure contains a garbage collection heap. The pre-processor performs a data flow analysis on the object-oriented code to determine objects that can be reclaimed and inserts a special bytecode in objects that can be reclaimed. Objects having the special bytecode are not placed in the garbage collection heap but are explicitly freed.

### BRIEF DESCRIPTION OF DRAWINGS

FIG. 1 is a general diagram depicting a garbage reduction system in accordance with an exemplary embodiment.

FIG. 2 is a diagram depicting an exemplary garbage reduction system in operation.

FIG. 3 is a diagram depicting a communication system including the garbage reduction system of FIG. 1.

### DETAILED DESCRIPTION OF EXEMPLARY EMBODIMENTS

There exists several different programming languages that interpret and include automatic memory management with garbage collection. Among the most popular are Java™, Visual C#, .NET™, Lisp, Objective-C, PHP, Perl, Python, Smalltalk, VBA, Visual Basic™ and VBScript™. In the following exemplary embodiments Java is used, but the same methods can be applied also other suitable languages.

The Java Virtual Machine (JVM) is a program that interprets Java bytecodes into machine code. The JVM is what makes Java portable. A vendor such as Microsoft Corporation of Redmond, Washington, or Sun Microsystems of Santa Clara, Calif., writes a JVM for their operating system, and any Java program can run on that JVM.

The JVM is an abstract computing machine. Like a real computing machine, it has an instruction set and manipulates various memory areas at run time. The JVM knows nothing of the Java programming language, only of a particular binary format, the class file format. A class file contains JVM instructions (or bytecodes) and a symbol table, as well as other ancillary information.

For the sake of security, the JVM imposes strong format and structural constraints on the code in a class file. However, any language with functionality that can be expressed in terms of a valid class file can be hosted by the JVM. Attracted by a generally available, machine-independent platform, implementors of other languages are turning to the JVM as a delivery vehicle for their languages.

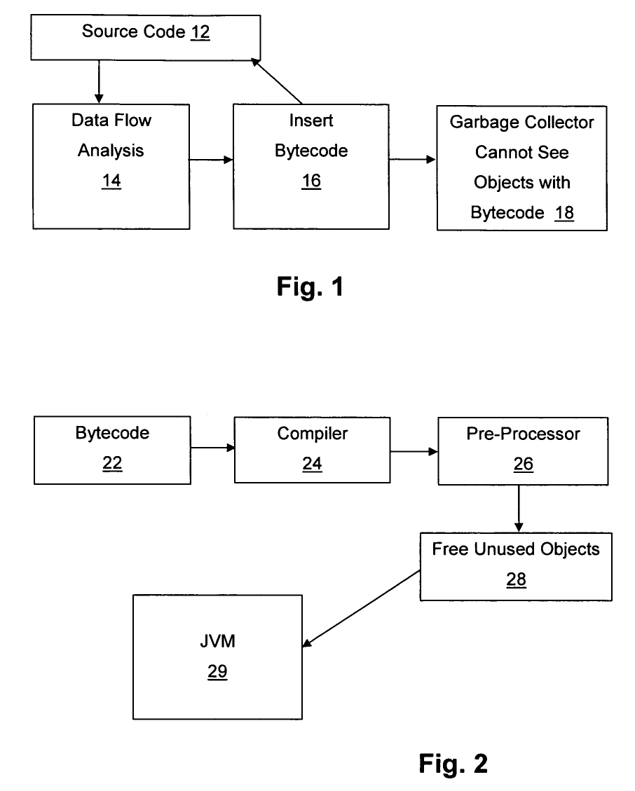

Referring now to the Figures, FIG. 1 illustrates operations performed in a garbage reduction process. Additional, fewer, or different operations may be performed depending on the embodiment. In an operation 14, source code 12 is subject to a data-flow analysis to determine points in the code when certain objects can be reclaimed. The source code 12 is the Java bytecode program. A data flow pre-processor inserts a special bytecode into the original source code 12 in an operation 16. The special bytecode allows the source code 12 to be reclaimed. In an operation 18, the garbage collector does not see the object with the inserted special bytecode.

The object from the source code 12 that is reclaimed doesn't reserve memory after it is not used anymore. As a result, the memory footprint of the JVM decreases and the responsiveness is better because the garbage collector has less work and, therefore, it interrupts the application less frequently and the interruptions are shorter.

FIG. 2 illustrates a garbage reduction system 20. Bytecode 22 is processed by a compiler 24 and then run through a pre-processor 26. The compiler 24 can be a Just-In-Time compiler. The pre-processor 26 finds no-escape points and inserts bytecode that explicitly frees unused objects in block 28. A Java Virtual Machine (JVM) 29 runs the bytecode 22 and supports the inserted bytecode that frees certain objects.

The modification of the compiled code by the pre-processor 26 can include inserting a data structure which can be used to deduce when objects can be reclaimed. For example, the data structure can be a table where there is a table per Java class that contains information for which object is deallocated at what location

Alternatively, although not preferred, method calls can be inserted into the Java source file to carry out the object reclaiming. Another alternative implementation is to perform data-flow analysis when the Java code is installed on a target system. This solution has the advantage of not breaking code compatibility because the Java bytecode is extended with the new instructions only if the JVM is able to execute the new bytecode statement.

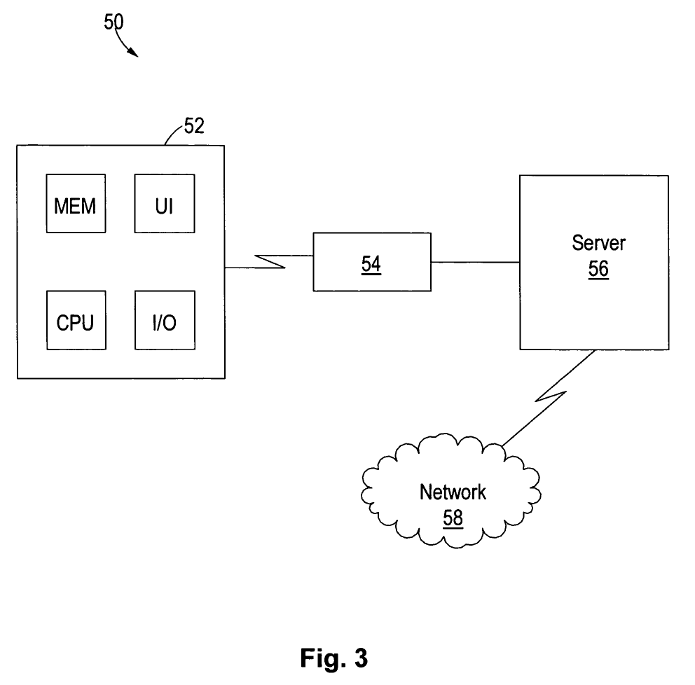

FIG. 3 illustrates a communication system 50 including the garbage reduction features described herein. The exemplary embodiments described herein can be applied to any telecommunications system including an electronic device with a speech recognition application, and a server, between which data can be transmitted.

Communication system 50 includes a terminal equipment (TE) device 52, an access point (AP) 54, a server 56, and a network 58. The TE device 52 can include memory (MEM), a central processing unit (CPU), a user interface (UI), and an input-output interface (I/O). The memory can include non-volatile memory for storing applications that control the CPU and random access memory for data processing. A context control module can be implemented by executing in the CPU programmed instructions stored in the memory. The I/O interface can include a network interface card of a wireless local area network, such as one of the cards based on the IEEE 802.11 standards.

The TE device 52 can be connected to the network 58 (e.g., a local area network (LAN), the Internet, a phone network) via the access point 54 and further to the server 56. The TE device 52 can also communicate directly with the server 56, for instance using a cable, infrared, or a data transmission at radio frequencies. The server 56 can provide various processing functions for the TE device 52.

The TE device 52 can be any portable electronic device, in which speech recognition is performed, for example a personal digital assistant (PDA) device, remote controller or a combination of an earpiece and a microphone. The TE device 52 can be a supplementary device used by a computer or a mobile station, in which case the data transmission to the server 56 can be arranged via a computer or a mobile station. In an exemplary embodiment, the TE device 52 is a mobile station communicating with a public land mobile network, to which also the server 56 is functionally connected. The TE device 52 connected to the network 58 includes mobile station functionality for communicating with the network 58 wirelessly. The network 18 can be any known wireless network, for instance a network supporting the GSM service, a network supporting the GPRS (General Packet Radio Service), or a third generation mobile network, such the UMTS (Universal Mobile Telecommunications System) network according to the 3GPP (3^{rd} Generation Partnership Project) standard. The functionality of the server 56 can also be implemented in the mobile network. The TE device 56 can be a mobile phone used for speaking only, or it can also contain PDA (Personal Digital Assistant) functionality.

While several embodiments of the invention have been described, it is to be understood that modifications and changes will occur to those skilled in the art to which the invention pertains. For example, although particular embodiments and implementations described contemplate use of the garbage reduction functionality with a communication device, such as a phone, other electronic devices may also include the functionalities described herein. Moreover, while the exemplary embodiments are described using the Java programming language, any object-oriented programming language may include the functionality as well. The invention is not limited to a particular embodiment, but extends to various modifications, combinations, and permutations that nevertheless fall within the scope and spirit of the appended claims.

1. A method of decreasing memory footprints produced in an programming environment, the method comprising:
analyzing compiled code to identify objects to be reclaimed;
modifying the compiled code to include instructions to reclaim objects found from said analysis.

2. The method of claim 1, further comprising reclaiming the identified objects at runtime based on instructions inserted to said modification.

3. The method of claim 1, wherein modifying the compiled code is done using a pre-processor.

4. The method of claim 1, wherein modifying the compiled code is done using a Just-In-Time compiler.

5. The method of claim 1, wherein modifying the compiled code comprises inserting bytecode.

6. The method of claim 1, wherein the compiled code is Java bytecode.

7. The method of claim 1, wherein modifying the compiled code comprises inserting method calls

8. The method of claim 1, wherein modification of compiled code comprises inserting a data structure which can be used to deduce when objects can be reclaimed.

9. The method of claim 1, wherein the modifications of compiled code are supported by a Java virtual machine that runs the modified code.

10. A system for decreasing memory footprints in an object-oriented programming environment, the system comprising: a pre-processor configured to find no escape points in object-oriented code and insert an unused object flag into the code to free unused objects in the object oriented code;
a virtual machine that executes the object-oriented code; and
a garbage collector that frees objects in a garbage collection heap containing used objects from executed object-oriented code, wherein code having the unused object flag does not go into the garbage collection heap and does not have to be freed by the garbage collector.

11. The system of claim 10, wherein virtual machine is a java virtual machine.

12. The system of claim 10, further comprising a compiler that compiles the object-oriented code.

13. The system of claim 10, wherein the pre-processor performs a data flow analysis to determine objects that can be reclaimed, said determined objects having the unused object flag inserted therein.

14. A device that having object-oriented programming code executed thereon, the device comprising:
a memory configured to contain object-oriented code;
a processor that performs a data flow analysis on the object-oriented code to determine objects that can be reclaimed, wherein the processor inserts special instructions about objects that can be reclaimed; and
a garbage collection heap configured to store unneeded objects until said unneeded objects can be freed, wherein the garbage collection heap is a space in the memory and the garbage collection heap does not contain determined in data flow analysis.

15. The device of claim 14, wherein the object-oriented code is Java bytecode.

16. The device of claim 14, wherein the data flow analysis is performed when the object-oriented code is installed.

17. The device of claim 14, wherein reclaiming the identified objects are reclaimed at runtime based on instructions inserted by the processor.

18. The device of claim 14, wherein the special instructions that the processor inserts comprises inserting bytecode.

19. The device of claim 14, wherein the special instructions that the processor inserts comprises inserting method calls.

20. The device of claim 14, wherein the special instructions that the processor inserts comprises inserting a data structure which can be used to deduce when objects can be reclaimed.

21. The device of claim 14, further comprising a virtual machine to interpret bytecode.

22. The device of claim 21, wherein the virtual machine supports the special instructions inserted by processor.

23. The system of claim 14, further comprising a java virtual machine that interprets Java bytecodes into machine code.

24. A computer program product that reduces memory needed to execute object-oriented code, the computer program product comprising:
computer code to insert a special bytecode into an original bytecode to identify objects to be reclaimed, wherein identified objects are no longer in use; and
computer code to reclaim the identified objects such that the identified objects do not reserve memory after not being used anymore.

25. The computer program product of claim 24, further comprising computer code to perform a data flow analysis to determine objects to be reclaimed.

26. The computer program product of claim 25, wherein the data flow analysis when the object-oriented code is installed.

27. The computer program product of claim 24, wherein the special bytecode is inserted after the original bytecode is compiled.

28. A module that decreases memory requirements for object-oriented code, the module comprising:
a memory structure containing a garbage collection heap; and
a pre-processor that performs a data flow analysis on the object-oriented code to determine objects that can be reclaimed, wherein the pre-processor inserts a special bytecode in objects that can be reclaimed, wherein objects having the special bytecode are not placed in the garbage collection heap but are explicitly freed.

29. The module of claim 28, wherein the object-oriented code is Java code.

30. The module of claim 28, wherein the data flow analysis is performed when the object-oriented code is installed.

31. The module of claim 28, further comprising a Java Virtual Machine that supports the special bytecode.
